(19) United States
(12) Patent Application Publication
(10) Pub. No.: US 2025/0130952 A1
(43) Pub. Date: Apr. 24, 2025

(54) MEMORY SYSTEM AND OPERATING METHOD FOR IMPROVING REBUILD EFFICIENCY

(71) Applicant: Yangtze Memory Technologies Co., Ltd., Wuhan (CN)

(72) Inventor: Zhihua TANG, Wuhan (CN)

(73) Assignee: Yangtze Memory Technologies Co., Ltd., Wuhan (CN)

(21) Appl. No.: 18/390,623

(22) Filed: Dec. 20, 2023

Related U.S. Application Data
(63) Continuation of application No. PCT/CN2023/126110, filed on Oct. 24, 2023.

(51) Int. Cl. G06F 12/1009; G06F 11/10; G06F 12/02

(52) U.S. Cl. CPC G06F 12/1009; G06F 11/1044; G06F 12/0253

(57) ABSTRACT

A method of operating a memory system can include maintaining one or more last write page table, the one or more last write page table is periodically updated to include at least one page serial number of the last page being written in a flash media, determining a last checkpoint in the flash media, the checkpoint is periodically updated and saved, determining the at least one page serial number in the one or more last write page table, validating a page having a highest page serial number in the one or more last write page table, validating pages having page serial numbers after the validated page having a page serial number in the one or more last write page table until an uncorrectable error correction code (UECC) occurs, and rebuilding mapping tables according to pages from the last checkpoint up to the last validated page before the UECC occurs.

### INCORPORATION BY REFERENCE

The present application is a bypass continuation application of International Application No. PCT/CN2023/126110, filed on Oct. 24, 2023, which is incorporated by reference herein in its entirety.

### TECHNICAL FIELD

The present disclosure relates to flash memory, and in particular to a method and system for improving performance after an abnormal power off.

### BACKGROUND

Non-volatile memory devices are sometimes referred to as flash memories, for example, NAND flash used in Solid State Drives (SSDs). SSDs provide a relatively reliable and easily accessible method of storing data when the power is off. However, SSDs still include volatile memory portions, such as static random access memory (SRAM) or dynamic random access memory (DRAM), for fast data transfer between a host and memory chips. When an abnormal power off happens, the data stored in the volatile memory portion may be lost or disrupted if not saved into the NAND memory.

### SUMMARY

Aspects of the disclosure provide a method of operating a memory system. The method can include maintaining one or more last write page table, the one or more last write page table is periodically updated to include at least one page serial number of the last page being written in a flash media, determining a last checkpoint in the flash media, the checkpoint is periodically updated and saved, determining the at least one page serial number in the one or more last write page table, validating a page having a highest page serial number in the one or more last write page table, validating pages having page serial numbers after the validated page having a page serial number in the one or more last write page table until an uncorrectable error correction code (UECC) occurs, and rebuilding mapping tables according to pages from the last checkpoint up to the last validated page before the UECC occurs.

In an embodiment, the maintaining the last write page table can further include updating the last write page table periodically to include at least one page serial number of a page of different data types. In an embodiment, the data type of the page is one of checkpoint type, garbage collection/merge type, or user data type.

In an embodiment, the one or more last write page table is periodically updated to include at least one page serial number of a page between two checkpoints.

In an embodiment, the one or more last write page table is periodically saved to the flash media. In an embodiment, the one or more last write page table is periodically saved when the checkpoint is saved into the flash media.

In an embodiment, in response to the page with the highest page serial number in the one or more last write page table is invalid, the method can further include validating a page with a second highest page serial number in the one or more last write page table.

Aspects of the disclosure provide a memory system including a controller and memory devices. The controller can be configured to maintain one or more last write page table, the one or more last write page table is periodically updated to include at least one page serial number of the last page being written in a flash media, determine a last checkpoint in the flash media, the checkpoint is periodically updated and saved, determine the at least one page serial number in the one or more last write page table, validate a page having a highest page serial number in the one or more last write page table, validate pages having page serial numbers after the validated page having a page serial number in the one or more last write page table until an uncorrectable error correction code (UECC) occurs, and rebuild mapping tables according to pages from the last checkpoint up to the last validated page before the UECC occurs.

Aspects of the disclosure provide non-transitory computer-readable medium storing instructions that, when executed by a processor, cause the processor to perform the method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of an example system 100 having a memory device, according to some aspects of the present disclosure.

FIG. 2A shows a diagram of an example memory card having a memory device, according to some aspects of the present disclosure.

FIG. 2B shows a diagram of an example solid-state drive (SSD) having a memory device, according to some aspects of the present disclosure.

FIG. 3 shows a schematic diagram of an example memory device including peripheral circuits, according to some aspects of the present disclosure.

FIG. 4 shows a side view of cross-sections of an example memory cell array including NAND memory strings, according to some aspects of the present disclosure.

FIG. 5 shows a block diagram of an example memory device including a memory cell array and peripheral circuits, according to some aspects of the present disclosure.

FIG. 6 shows an example of block layout according to aspects of the present disclosure.

FIG. 7 shows the effects of an abnormal power off on data stored on SSD.

FIG. 8 shows a process 800 of power off recovery during normal flow.

FIG. 9 shows a flowchart of the block rebuilding process in SSD.

FIG. 10 shows an example of sorting pages with different data during sudden power off recovery.

FIG. 11 shows an example of sorting pages with last write page tables according to the present disclosure.

FIG. 12 shows a process 1200 of rebuilding mapping tables according to aspects of the present disclosure.

### DETAILED DESCRIPTION OF EMBODIMENTS

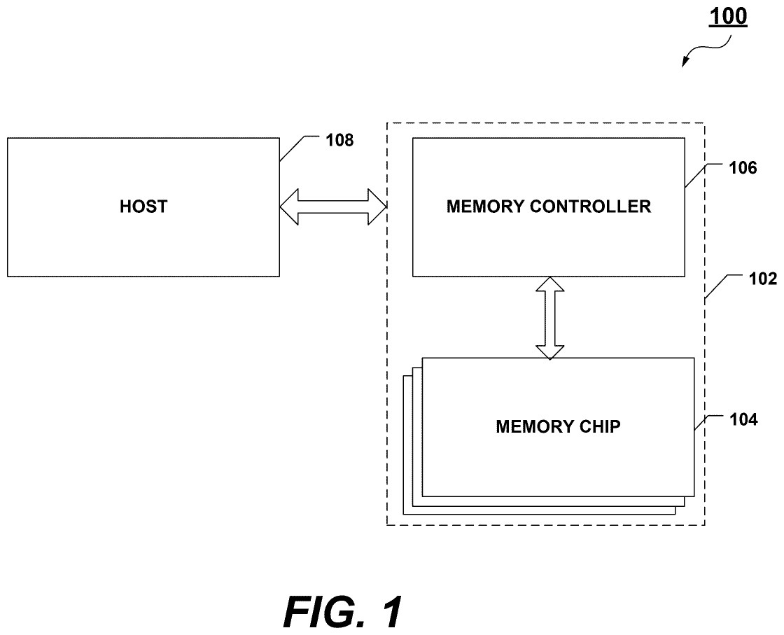

FIG. 1 shows a block diagram of an example system 100 having a memory device, according to some aspects of the present disclosure. System 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, system 100 can include a host 108 and a memory system 102 having one or more memory devices 104 and a memory controller 106. Host 108 can be a processor of an electronic device, such as a central processing unit (CPU), or a system-on-chip (SoC), such as an application processor (AP). Host 108 can be configured to send or receive data to or from memory devices 104.

Memory controller 106 is coupled to memory device 104 and host 108 and is configured to control memory device 104, according to some implementations. Memory controller 106 can manage the data stored in memory device 104 and communicate with host 108. In some implementations, memory controller 106 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment SSDs or embedded multi-media-cards (eMMCs) used as data storage for mobile devices, such as smartphones, tablets, laptop computers, etc., and enterprise storage arrays. Memory controller 106 can be configured to control operations of memory device 104, such as read, erase, and program operations. Memory controller 106 can also be configured to manage various functions with respect to the data stored or to be stored in memory device 104 including, but not limited to bad-block management, garbage collection, logical-to-physical address conversion, wear leveling, etc. In some implementations, memory controller 106 is further configured to process error correction codes (ECCs) with respect to the data read from or written to memory device 104. Any other suitable functions may be performed by memory controller 106 as well, for example, formatting memory device 104. Consistent with some aspects of the present disclosure, memory controller 106 is configured to perform mapping table rebuilding after an abnormal power off recovery, as described below in detail.

Memory controller 106 can communicate with an external device (e.g., host 108) according to a particular communication protocol. For example, memory controller 106 may communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

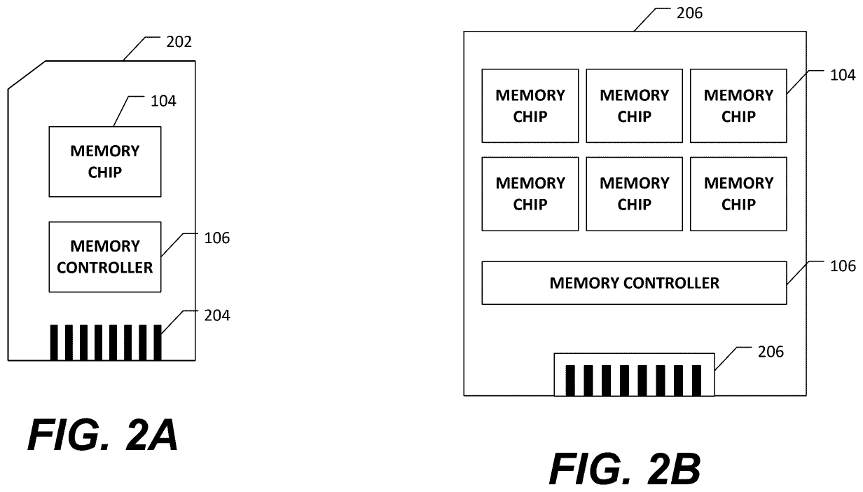

Memory controller 106 and one or more memory devices 104 can be integrated into various types of storage devices, for example, be included in the same package, such as a universal Flash storage (UFS) package or an eMMC package. That is, memory system 102 can be implemented and packaged into different types of end electronic products. In one example as shown in FIG. 2A, memory controller 106 and a single memory device 104 may be integrated into a memory card 202. Memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. Memory card 202 can further include a memory card connector 204 coupling memory card 202 with a host (e.g., host 108 in FIG. 1). In another example as shown in FIG. 2B, memory controller 106 and multiple memory devices 104 may be integrated into an SSD 206. SSD 206 can further include an SSD connector 208 coupling SSD 206 with a host (e.g., host 108 in FIG. 1). In some implementations, the storage capacity and/or the operation speed of SSD 206 is greater than those of memory card 202.

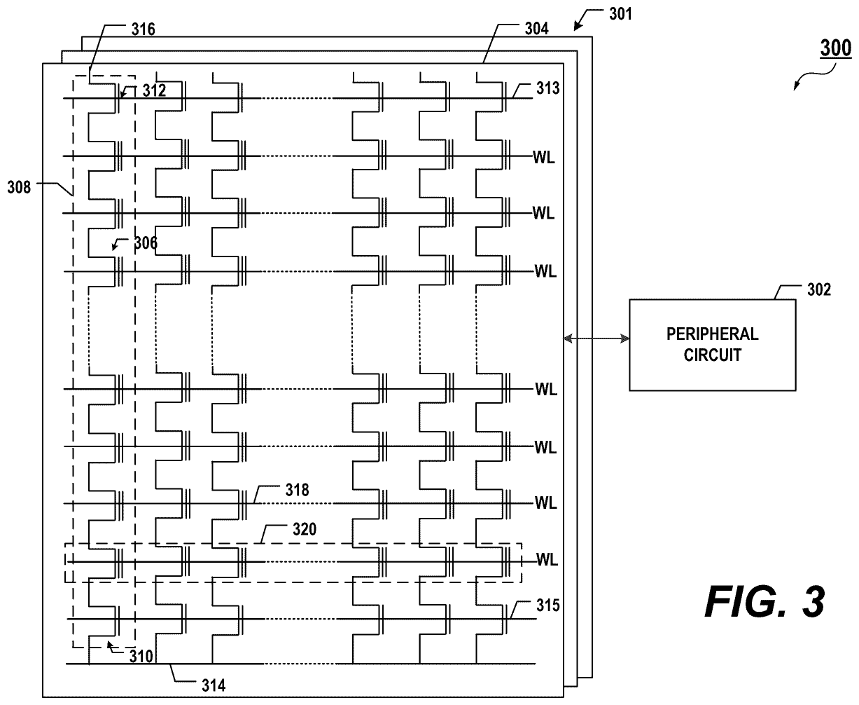

FIG. 3 shows a schematic circuit diagram of an example memory device 300 including peripheral circuits, according to some aspects of the present disclosure. Memory device 300 can be an example of memory device 104 in FIG. 1. Memory device 300 can include a memory cell array 301 and peripheral circuits 302 coupled to memory cell array 301. Memory cell array 301 can be a NAND Flash memory cell array in which memory cells 306 are provided in the form of an array of NAND memory strings 308 each extending vertically above a substrate (not shown). In some implementations, each NAND memory string 308 includes a plurality of memory cells 306 coupled in series and stacked vertically. Each memory cell 306 can hold a continuous, analog value, such as an electrical voltage or charge, that depends on the number of electrons trapped within a region of memory cell 306. Each memory cell 306 can be either a floating gate type of memory cell including a floating-gate transistor or a charge trap type of memory cell including a charge-trap transistor.

In some implementations, each memory cell 306 is a single-level cell (SLC) that has two possible memory states and thus, can store one bit of data. For example, the first memory state “0” can correspond to a first range of voltages, and the second memory state “1” can correspond to a second range of voltages. In some implementations, each memory cell 306 is a multi-level cell (MLC) that is capable of storing more than a single bit of data in more than four memory states. For example, the MLC can store two bits per cell, three bits per cell (also known as triple-level cell (TLC)), or four bits per cell (also known as a quad-level cell (QLC)). Each MLC can be programmed to assume a range of possible nominal storage values. In one example, if each MLC stores two bits of data, then the MLC can be programmed to assume one of three possible programming levels from an erased state by writing one of three possible nominal storage values to the cell. A fourth nominal storage value can be used for the erased state.

As shown in FIG. 3 each NAND memory string 308 can include a source select gate (SSG) 310 at its source end and a drain select gate (DSG) 312 at its drain end. SSG 310 and DSG 312 can be configured to activate selected NAND memory strings 308 (columns of the array) during read and program operations. In some implementations, the sources of NAND memory strings 308 in the same block 304 are coupled through a same source line (SL) 314, e.g., a common SL. In other words, all NAND memory strings 308 in the same block 304 have an array common source (ACS), according to some implementations. DSG 312 of each NAND memory string 308 is coupled to a respective bit line 316 from which data can be read or written via an output bus (not shown), according to some implementations. In some implementations, each NAND memory string 308 is configured to be selected or deselected by applying a select voltage (e.g., above the threshold voltage of the transistor having DSG 312) or a deselect voltage (e.g., 0 V) to respective DSG 312 through one or more DSG lines 313 and/or by applying a select voltage (e.g., above the threshold voltage of the transistor having SSG 310) or a deselect voltage (e.g., 0 V) to respective SSG 310 through one or more SSG lines 315.

As shown in FIG. 3, NAND memory strings 308 can be organized into multiple blocks 304, each of which can have a common source line 314, e.g., coupled to the ACS. In some implementations, each block 304 is the basic data unit for erase operations, i.e., all memory cells 306 on the same block 304 are erased at the same time. To erase memory cells 306 in a selected block 304, source lines 314 coupled to selected block 304 as well as unselected blocks 304 in the same plane as selected block 304 can be biased with an erase voltage (Vers), such as a high positive voltage (e.g., 20 V or more). It is understood that in some examples, erase operation may be performed at a half-block level, a quarter-block level, or a level having any suitable number of blocks or any suitable fractions of a block. Memory cells 306 of adjacent NAND memory strings 308 can be coupled through word lines 318 that select which row of memory cells 306 is affected by read and program operations. In some implementations, each word line 318 is coupled to a plurality of memory cells 306 in one block.

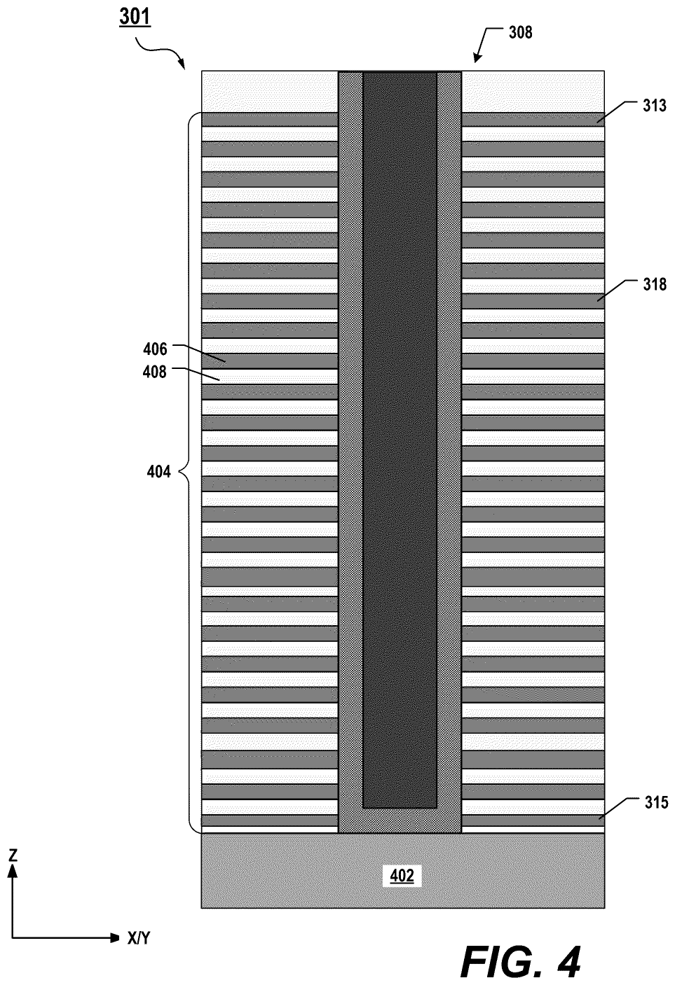

FIG. 4 shows a cross-sectional schematic diagram of an example memory array 301 including NAND memory strings 308 in accordance with some aspects of the present invention. The NAND memory string 308 may include a stacked structure 404, the stacked structure 404 including a plurality of gate layers 406 and a plurality of insulating layers 408 alternately stacked in sequence, and the memory string 308 vertically penetrating the gate layers 406 and the insulating layers 408. The gate layers 406 and the insulating layers 408 may be alternately stacked, and adjacent two gate layers 406 are separated by one insulating layer 408. The number of pairs of the gate layer 406 and the insulating layer 408 in the stacked structure 404 may determine the number of memory cells included in the memory array 301.

The constituent material of the gate layer 406 may include a conductive material. The conductive material includes, but is not limited to, tungsten (W), cobalt (Co), copper (Cu), aluminum (Al), polysilicon, doped silicon, silicide, or any combination thereof. In some embodiments, each gate layer 406 includes a metal layer, e.g., a tungsten layer. In some embodiments, each gate layer 406 comprises a doped polysilicon layer. Each gate layer 406 may include a control gate surrounding a memory cell. The gate layer 406 at the top of the stacked structure 404 may laterally extend as an upper select gate line, the gate layer 406 at the bottom of the stacked structure 404 may laterally extend as a lower select gate line, and the gate layer 406 extending laterally between the upper and lower select gate lines may serve as a word line layer.

In some embodiments, the stacked structure 404 may be disposed on the substrate 402. The substrate 402 may include silicon (e.g., single crystal silicon), silicon germanium (SiGe), gallium arsenide (GaAs), germanium (Ge), silicon-on-insulator (SOI), germanium-on-insulator (GOI), or any other suitable material.

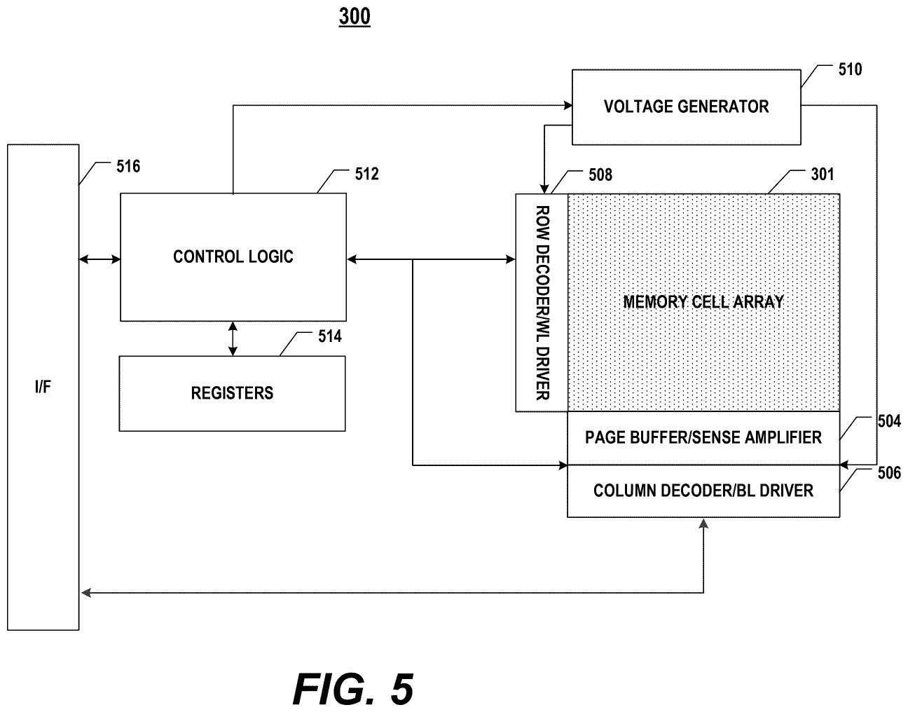

Peripheral circuits 302 can be coupled to memory cell array 301 through bit lines 316, word lines 318, source lines 314, SSG lines 315, and DSG lines 313. Peripheral circuits 302 can include any suitable analog, digital, and mixed-signal circuits for facilitating the operations of memory cell array 301 by applying and sensing voltage signals and/or current signals to and from each target memory cell 306 through bit lines 316, word lines 318, source lines 314, SSG lines 315, and DSG lines 313. Peripheral circuits 302 can include various types of peripheral circuits formed using metal-oxide-semiconductor (MOS) technologies. For example, FIG. 5 illustrates some example peripheral circuits including a page buffer/sense amplifier 504, a column decoder/bit line driver 506, a row decoder/word line driver 508, a voltage generator 510, control logic 512, registers 514, an interface 516, and a data bus 518. It is understood that in some examples, additional peripheral circuits not shown in FIG. 5 may be included as well.

Page buffer/sense amplifier 504 can be configured to read and program (write) data from and to memory cell array 301 according to the control signals from control logic 512. In one example, page buffer/sense amplifier 504 may store one page of program data (write data) to be programmed into memory cells 306. In another example, page buffer/sense amplifier 504 may perform program verify operations to ensure that the data has been properly programmed into memory cells 306 coupled to selected word lines 318. In still another example, page buffer/sense amplifier 504 may also sense the low power signals from bit line 316 that represents a data bit stored in memory cell 306 and amplify the small voltage swing to recognizable logic levels in a read operation. Column decoder/bit line driver 506 can be configured to be controlled by control logic 512 and select one or more NAND memory strings 308 by applying bit line voltages generated from voltage generator 510.

Row decoder/word line driver 508 can be configured to be controlled by control logic 512 and select/deselect blocks 304 of memory cell array 301 and select/deselect word lines 318 of block 304. Row decoder/word line driver 508 can be further configured to drive word lines 318 using word line voltages generated from voltage generator 510. In some implementations, row decoder/word line driver 508 can also select/deselect and drive SSG lines 315 and DSG lines 313 as well. Row decoder/word line driver 508 can be configured to apply a read voltage to selected word line 318 in a read operation on memory cell 306 coupled to selected word line 318.

Voltage generator 510 can be configured to be controlled by control logic 512 and generate the word line voltages (e.g., read voltage, program voltage, pass voltage, local voltage, verification voltage, etc.), bit line voltages, and source line voltages to be supplied to memory cell array 301. Control logic 512 can be coupled to each peripheral circuit described above and configured to control operations of each peripheral circuit. Registers 514 can be coupled to control logic 512 and include status registers, command registers, and address registers for storing status information, command operation codes (OP codes), and command addresses for controlling the operations of each peripheral circuit.

Interface 516 can be coupled to control logic 512 and act as a control buffer to buffer and relay control commands received from a host (not shown) to control logic 512 and status information received from control logic 512 to the host. Interface 516 can also be coupled to column decoder/bit line driver 506 via data bus 518 and act as a data input/output (I/O) interface and a data buffer to buffer and relay the data to and from memory cell array 301.

Refer back to FIG. 1, the memory controller 106 can be configured to maintain a mapping table that is used for mapping the logical addresses to the corresponding physical addresses. In some implementations, the number of the logical addresses is different than the number of the physical addresses. For example, data stored in multiple logical addresses can be written in memory cells having one physical address. The mapping table can be referred as a logical-to-physical (L2P) table for mapping the two addresses. To retrieve a specific piece of data, the host 108 can provide a logical address of the target data and the memory controller can utilize L2P mapping tables to identify a physical address of the target data in the memory device 104 and retrieve the stored data.

Several approaches can be used for storing and maintaining L2P mapping tables. One such approach is single-level direct L2P mapping. Under such mapping scheme, the mapping table includes an entry for each page and a summary page for metadata at the end of each block that contains logical block address information. The L2P mapping table can be stored in a memory device within the flash memory controller. For example, the L2P mapping table can be stored in a static random access memory (SRAM) device. For example, the L2P mapping table can be stored in a dynamic random access memory (DRAM) device. Single-level direct L2P mapping can contain the mapping information for the entire flash memory devices. Therefore, the single-level direct page mapping scheme requires a large amount of storage space (in the order of 1-2 MB per GB of user storage) to store the L2P mapping table.

Another approach for storing and maintaining L2P mapping tables is the multi-level mapping schemes. For example, multi-level mapping schemes can group together a number of adjacent logical blocks and can include a page global directory for each grouped blocks. The page global directories can be stored in a memory device (e.g., SRAM or DRAM) within the flash memory controller for quick access. The mapping scheme also includes page middle directories and page tables that are stored and maintained in pages located at a memory cell level in the spare areas of the NAND memory devices. Page tables contain physical block numbers and physical page numbers of the data.

A flash translation layer (“FTL”) is an algorithm that can be performed in the memory controller 106 for translating a logical address to a physical address. Under the single-level direct L2P mapping, FTL can be utilized to read and scan the L2P mapping table stored within the flash memory controller. Under the multi-level mapping scheme, the FTL can be utilized to read the page global directory stored in the flash memory controller and access the spare memory cells of the NAND memory devices for the page middle directories and the page tables in order to retrieve the requested data address.

Since the L2P mapping tables are usually stored in volatile memory devices such as SRAM or DRAM for faster access during operation, they are vulnerable to power loss. During scheduled power off, the L2P mapping tables can be saved to the NAND flash memory device prior to power loss by the memory controller. The L2P mapping tables can be rebuilt or restored from the saved data from the memory device by the host. However, when an abnormal power off event (e.g., sudden power off event) happens, the L2P mapping tables could not be saved to the memory device in time, and the data stored therein are lost. The memory system needs to go through sudden power off recovery to recover the last status after power on again.

During power on, the memory controller begins by reading metadata stored in the NAND flash memory device. The metadata can contain information about the NAND flash memory devices such as structure, block status, wear-leveling data, and any bad blocks. The memory controller also reads checkpoint data that are stored in the NAND flash memory. The checkpoints indicate the data stored prior to the checkpoints are validated to be stored in the NAND flash memory cells. For example, the checkpoint can indicate the page serial number of a page that has been validated to be stored in the NAND flash memory. The checkpoints are created by the FTL periodically or when specific conditions are met. For example, the FTL can create a checkpoint every few blocks of data that has been written in the NAND flash memory.

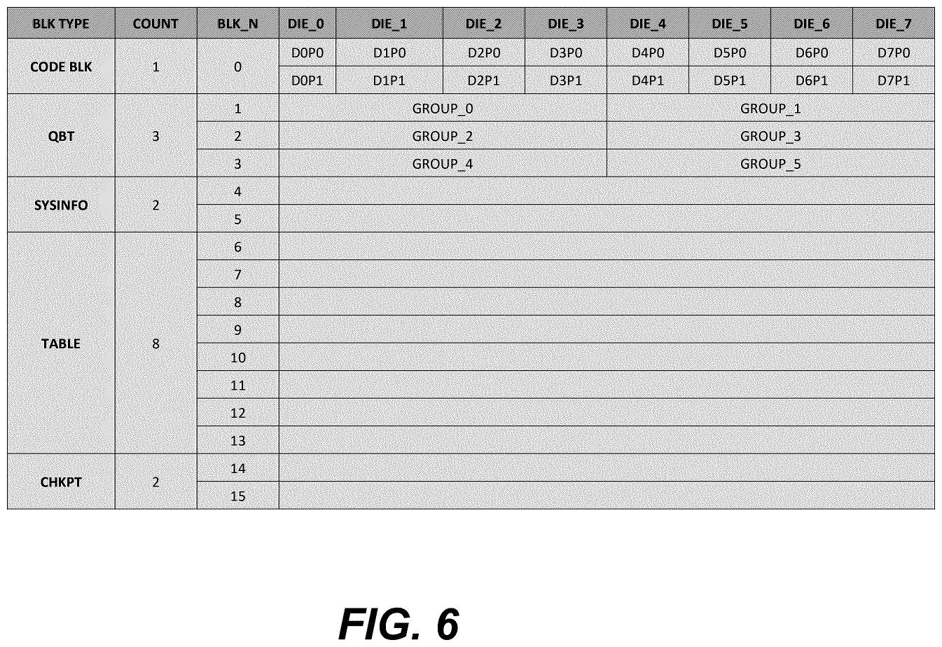

FIG. 6 shows an example of block layout according to aspects of the present disclosure. An SSD can include code blocks (CODE BLK), quick boot tables (QBT), system information blocks (SYSINFO), table blocks (TABLE), and checkpoint blocks (CHKPT). For example, as shown in FIG. 6, an SSD can include eight dies of memory cells and can include one code block, three quick boot tables, two system information blocks, eight table blocks, and two checkpoint blocks. The code block can be used to store firmware bins. Each die can include two blocks that are used for code blocks. The quick boot table can be used to store the subsequent index of the checkpoint index and can be used in a normal power off recovery. Each quick boot table can be divided into two groups, each group covers four dies. The system information block can be used to store metadata such as error logs and event logs. The table block can be used to store mapping tables (e.g., L2P tables), bad block tables, wear-leveling tables, and the like. The checkpoint block can be used to store snapshots of data (i.e., checkpoints) stored on the NAND flash memory.

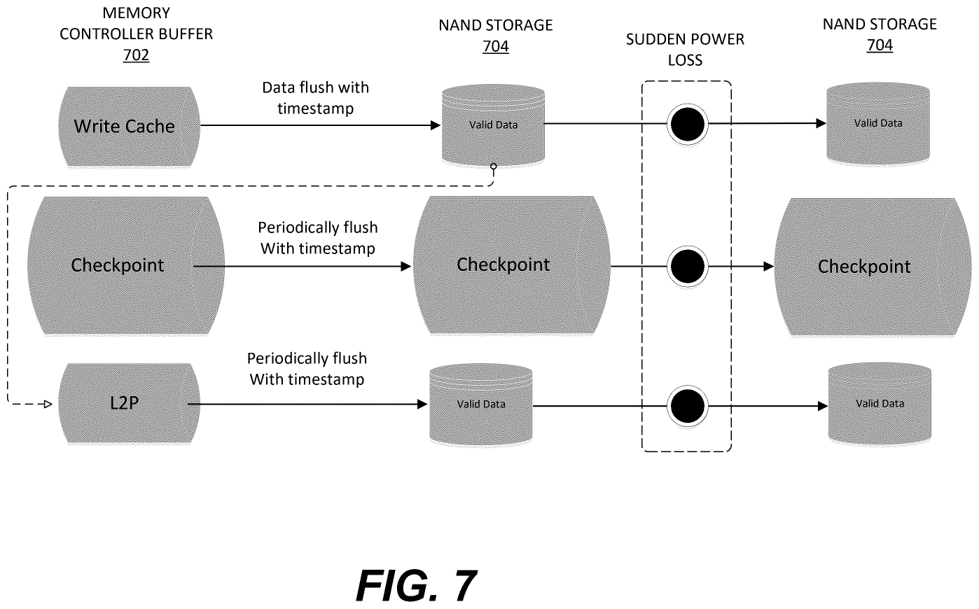

FIG. 7 shows the effects of an abnormal power off on data stored on SSD. The sudden power off can affect the cache written into NAND flash memory. During normal SSD operation, host data cached in a memory controller buffer 702 are flushed with timestamps to the NAND storage 704. Checkpoint information stored in the memory controller buffer 702 is flushed to the NAND storage 704 periodically with timestamps. The checkpoint information can be used to indicate the primary mapping table and/or the secondary mapping table of different blocks of the NAND flash memory. The L2P mapping table temporarily stored in the memory controller buffer 702 is flushed with timestamps to the NAND storage 704. When an abnormal power loss happens, the host data, checkpoint information, and L2P mapping table that has not yet been flushed to the NAND storage 704 may be lost or corrupted, which can affect the data integrity of the SSD.

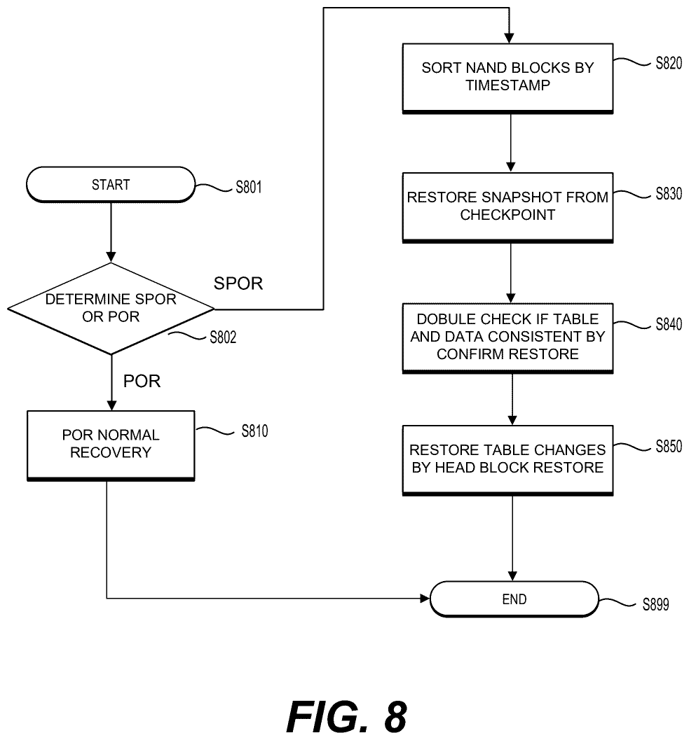

FIG. 8 shows a process of power off recovery during normal flow. The process can start from S801 and proceed to S802.

At S802, a memory controller can validate quick boot tables (QBT) stored in the system. If it is determined that the QBTs are valid, the process can proceed to S810 to perform QBT recovery and can end at S899.

If the memory controller determines that the QBTs are invalid, the process can proceed to S820 to perform an abnormal power off rebuild flow.

At S820, the memory controller can sort pages within NAND blocks by timestamps. Different data flushed into NAND blocks may not follow the logical address of the host or memory controller. For example, two consecutive pages can store table data and host data, while their logical addresses may not be consecutive. Therefore, NAND blocks in the SSD need to be sorted by the timestamps of the NAND blocks.

At S830, the memory controller can restore snapshots from a checkpoint. The snapshots can be restored according to the sorted NAND blocks and the timestamps of each page/block are associated.

At S840, the memory controller can double check if the table data or host data is consistent by confirming restore.

At S850, the memory controller can restore table changes by head block restore. The memory controller can update any mapping tables according to restored NAND blocks. The process can proceed to S899 and end at S899.

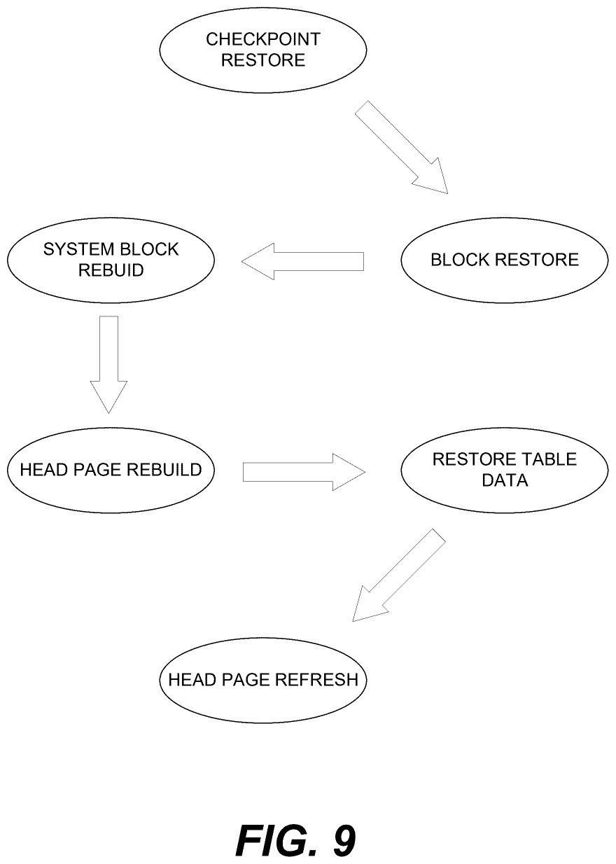

FIG. 9 shows a flowchart of the block rebuilding process in SSD. The rebuilding follows the order as shown in FIG. 9, checkpoint information is restored first, followed by data blocks such as host data blocks, table blocks, and any other data type blocks. Data flushed before the checkpoint can be considered valid, therefore the rebuild process starts from the last valid checkpoint. System information blocks are rebuilt next followed by a head page rebuild. Each block can include one head page and the head page can include metadata of the block or user data. The head page of each block is rebuilt according to the restore blocks and rebuilt system information blocks. Table and host data can be restored next according to the pages restored or rebuilt since the rebuilding process begins. The head page can be refreshed accordingly to include the updated metadata of the respective block at the end.

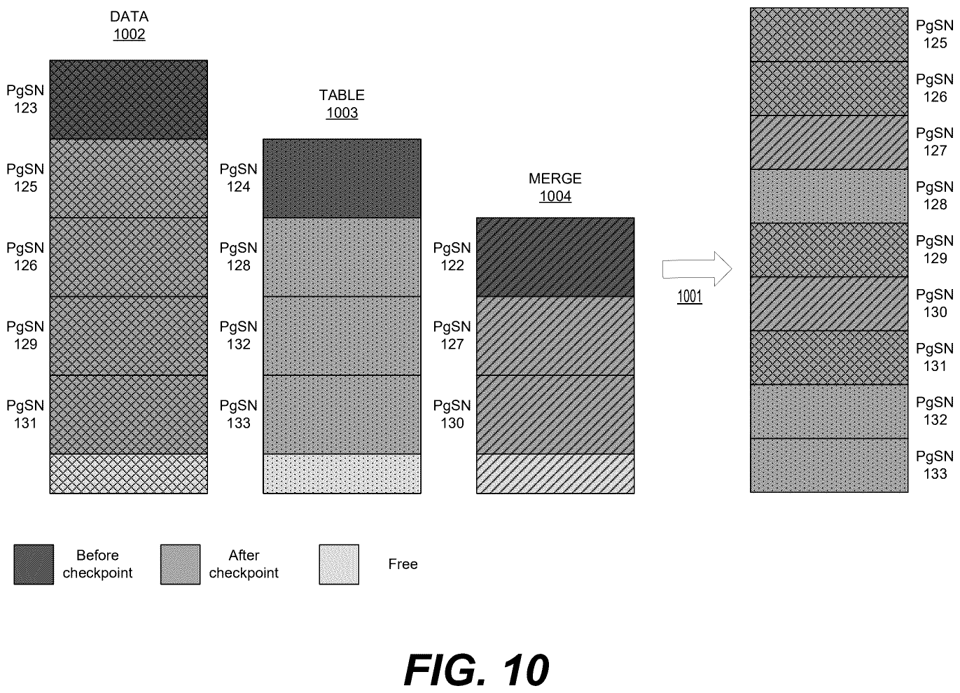

FIG. 10 shows an example of sorting pages with different data during sudden power off recovery. Pages shown on the right side of the sorting process 1001 represent the pages stored in the NAND memory. The pages are sorted according to the data type of the page (e.g., sorted in data block 1002, table block 1003, garbage collection/merge block 1004, etc.). Pages within each block may not have a consecutive page serial number (i.e., page index). Since the pages before the checkpoint in each block can be considered valid, the sorting process 1001 only needs to sort and validate pages that are flushed after the checkpoint. The sorting process 1001 sorts the pages according to the PgSN regardless of the data type of the page. The sorted pages (i.e., right side of the sorting process 1001) can then be validated until an uncorrectable error correction code occurs.

However, depending on the system preferences, the number of pages after checkpoints that need to be sorted and validated can be large. The number of pages that need to be validated directly affects the sudden power off recovery time which affects the power on time of the system. Therefore, a last write page can be determined periodically to reduce the number of pages that need to be validated according to aspects of the present disclosure.

In an embodiment, a memory controller can periodically save the index (e.g., PgSN) of a last write page of different types of pages. Each type of page can have different suitable saving frequencies of the last write page PgSN. In an embodiment, the memory controller can save the PgSN of a last write page after a fixed number of pages of the same type have been flushed into the NAND memory. In an embodiment, the memory controller can save a PgSN of a last write page after a fixed time has passed.

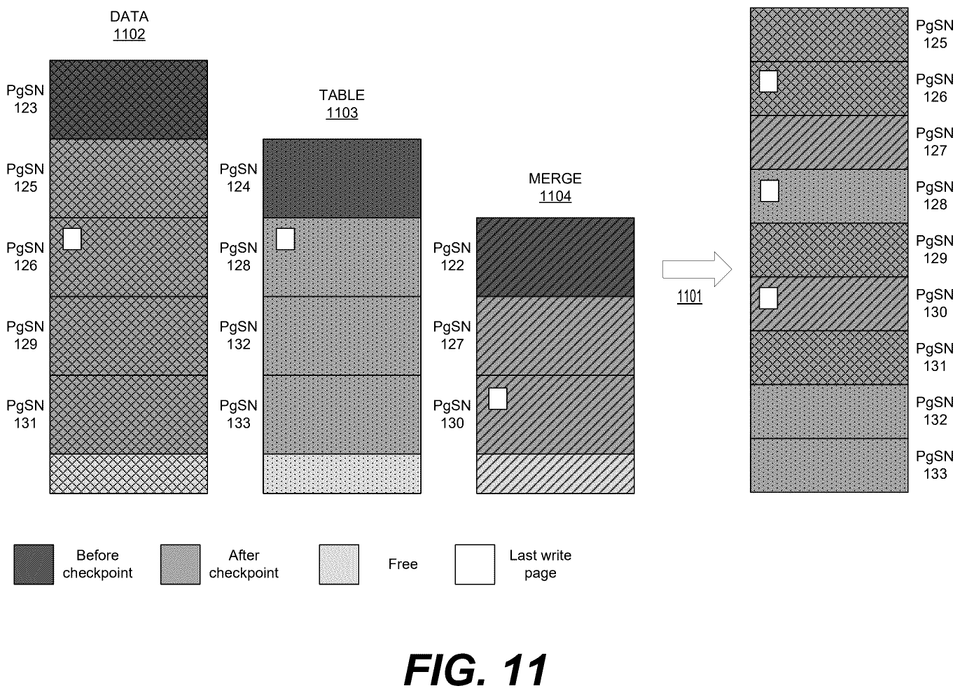

FIG. 11 shows an example of sorting pages with last write page table according to the present disclosure. The pages stored in the NAND memory is in the same order as the pages shown in FIG. 11. The difference is that a last write page for each data block is recorded. A last write page is recorded for the page with PgSN 126 for the data block 1102, for the page with PgSN 128 for the table block 1102, and for the page with PgSN 130 for the GC/merge block 1203. In some embodiments, a table of PgSN of the last write pages of the different data blocks can be temporarily saved in an SRAM and periodically flushed to a dedicated section of the NAND memory. In some embodiments, the memory controller records the PgSN of a last write page at least once between two checkpoints for each block.

During the sorting process 1101, the memory controller needs to determine the checkpoints of each block first and then scan the last write page table stored in the NAND memory. For example, the memory controller can scan the last write page table and determine that PgSN 126, 128, and 130 are stored within. The memory controller can then scan the page with the highest PgSN to validate the data within the page with PgSN 130. If the page is validated, the memory controller can start performing the rebuild and restore process on any pages sorted after the page with the highest PgSN in the last write page table. For example, as shown in FIG. 11, the memory controller can determine the data is valid within the Page with PgSN 130, and only need to validate pages with PgSN 131, 132, and 133 until a UECC occurs.

However, in some cases, the sudden power off can happen when the last write page table is being updated. For example, the page with the highest PgSN in the last write page table is invalid although the PgSN is flushed in the NAND memory. In such a case, the memory controller needs to validate the page with the second highest PgSN in the last write page table. For example, as shown in FIG. 11, when the memory controller determines the data of the page with PgSN 130 is invalid, it proceeds to scan and validate the page with PgSN 128. If validated, the memory controller can validate the pages after the page with PgSN 128 until a UECC occurs. Otherwise, the memory controller can validate the previous page with a PgSN in the last write page table until one can be validated, then proceed to validate any pages after the validated page with a PgSN in the last write page table until a UECC occurs. The memory controller can then rebuild mapping tables using all the pages from the checkpoint until the last page before the UECC occurs.

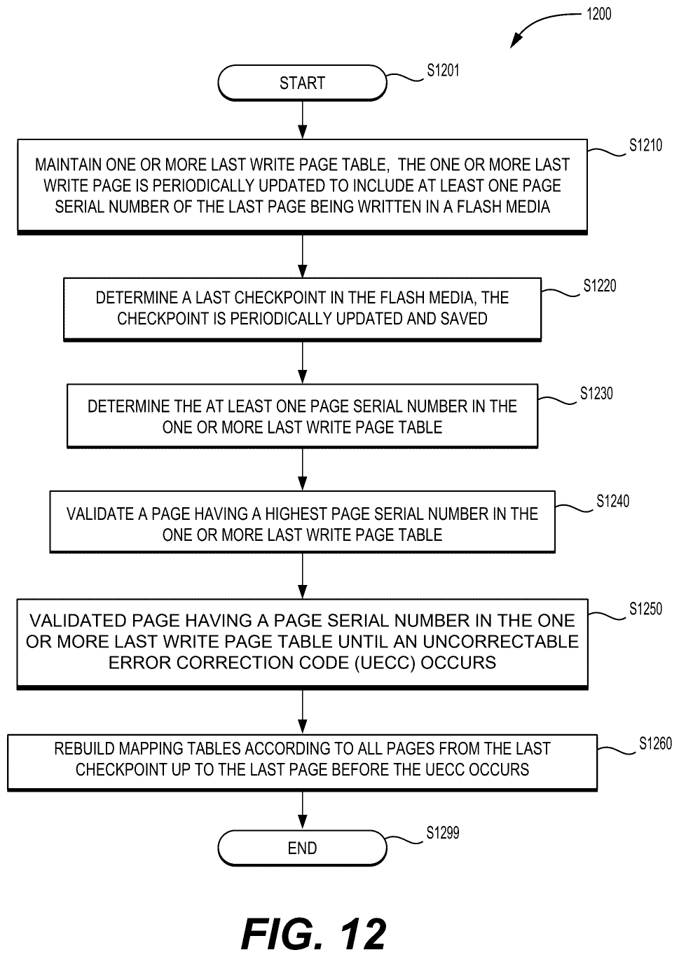

FIG. 12 shows a process 1200 of rebuilding mapping tables according to aspects of the present disclosure. In some embodiments, the process 1200 is executed by a memory controller, such as by a memory controller 106 of the memory system 102. The process 1200 can start from S1201 and proceed to S1210.

At S1210, a memory controller can maintain one or more last write page table. The one or more last write page table is periodically updated to include at least one page serial number of the last page being written in a flash media. In one embodiment, the one or more last write page table is updated periodically to include at least one page serial number of a page of different data types. For example, one last write page table can be maintained to include one page serial number of a last write page in a table block, one page serial number of a last write page in a data block, and/or one page serial number of a last write page in a garbage collection/merge block.

In one embodiment, the one or more last write page table is flushed into the flash media. In one embodiment, the one or more last write page table is periodically updated to include at least one page serial number of a page between two checkpoints. In one embodiment, the one or more last write page table is periodically saved when the checkpoint is saved into the flash media. In one embodiment, the one or more last write page table is temporarily saved in a SRAM.

At S1220, a memory controller can determine a last checkpoint in the flash media, the checkpoint is periodically updated and saved.

At S1230, a memory controller can determine the at least one page serial number in the one or more last write page table. For example, the memory controller can read any page serial number in the last write page table that is saved in the flash media.

At S1240, a memory controller can validate a page having a highest page serial number in the one or more last write page table. In one embodiment, if the page with the highest page serial number in the one or more last write page table is invalid, the memory controller can validate a page with a second highest page serial number in the one or more last write page table, and continue validating until a page with page serial number in the one or more last write page table is valid or the last checkpoint is read.

At S1250, a memory controller can validate pages having page serial numbers after the validated page having a page serial number in the one or more last write page table until an uncorrectable error correction code (UECC) occurs.

At S1260, a memory controller can rebuild mapping tables according to all pages from the last checkpoint up to the last page before the UECC occurs. The process 1200 can then proceeds to S1299 and terminates at S1299.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method of operating a memory system, comprising:
maintaining one or more last write page table, the one or more last write page table is periodically updated to include at least one page serial number of the last page being written in a flash media;
determining a last checkpoint in the flash media, the checkpoint is periodically updated and saved;
determining the at least one page serial number in the one or more last write page table;
validating a page having a highest page serial number in the one or more last write page table;
validating pages having page serial numbers after the validated page having a page serial number in the one or more last write page table until an uncorrectable error correction code (UECC) occurs; and
rebuilding mapping tables according to pages from the last checkpoint up to the last validated page before the UECC occurs.

2. The method of claim 1, wherein maintaining the last write page table further comprises updating the last write page table periodically to include at least one page serial number of a page of different data types.

3. The method of claim 2, wherein the data type of the page is one of checkpoint type, garbage collection/merge type, or user data type.

4. The method of claim 1, wherein the one or more last write page table is periodically updated to include at least one page serial number of a page between two checkpoints.

5. The method of claim 1, wherein the one or more last write page table is periodically saved to the flash media.

6. The method of claim 5, wherein the one or more last write page table is periodically saved when the checkpoint is saved into the flash media.

7. The method of claim 1, further comprising:
in response to the page with the highest page serial number in the one or more last write page table is invalid, validating a page with a second highest page serial number in the one or more last write page table.

8. A memory system comprising a controller and memory devices, the controller being configured to:
maintain one or more last write page table, the one or more last write page table is periodically updated to include at least one page serial number of the last page being written in a flash media;
determine a last checkpoint in the flash media, the checkpoint is periodically updated and saved;
determine the at least one page serial number in the one or more last write page table;
validate a page having a highest page serial number in the one or more last write page table;
validate pages having page serial numbers after the validated page having a page serial number in the one or more last write page table until an uncorrectable error correction code (UECC) occurs; and
rebuild mapping tables according to pages from the last checkpoint up to the last validated page before the UECC occurs.

9. The memory system of claim 8, wherein the controller is further configured to update the last write page table periodically to include at least one page serial number of a page of different data types.

10. The memory system of claim 9, wherein the data type of the page is one of checkpoint type, garbage collection/merge type, or user data type.

11. The memory system of claim 8, wherein the one or more last write page table is periodically updated to include at least one page serial number of a page between two checkpoints.

12. The memory system of claim 8, wherein the one or more last write page table is periodically saved to the flash media.

13. The memory system of claim 12, wherein the one or more last write page table is periodically saved when the checkpoint is saved into the flash media.

14. The memory system of claim 8, further comprises:
in response to the page with the highest page serial number in the one or more last write page table is invalid, validate a page with a second highest page serial number in the one or more last write page table.

15. A non-transitory computer-readable medium storing instructions that, when executed by a processor, cause the processor to perform a method, the method comprising:
maintaining one or more last write page table, the one or more last write page table is periodically updated to include at least one page serial number of the last page being written in a flash media;
determining a last checkpoint in the flash media, the checkpoint is periodically updated and saved;
determining the at least one page serial number in the one or more last write page table;
validating a page having a highest page serial number in the one or more last write page table;
validating pages having page serial numbers after the validated page having a page serial number in the one or more last write page table until an uncorrectable error correction code (UECC) occurs; and
rebuilding mapping tables according to pages from the last checkpoint up to the last validated page before the UECC occurs.

16. The non-transitory computer-readable medium of claim 15, wherein maintaining the last write page table further comprises updating the last write page table periodically to include at least one page serial number of a page of different data types.

17. The non-transitory computer-readable medium of claim 16, wherein the data type of the page is one of checkpoint type, garbage collection/merge type, or user data type.

18. The non-transitory computer-readable medium of claim 15, wherein the one or more last write page table is periodically updated to include at least one page serial number of a page between two checkpoints.

19. The non-transitory computer-readable medium of claim 15, wherein the one or more last write page table is periodically saved to the flash media.

20. The non-transitory computer-readable medium of claim 19, wherein the one or more last write page table is periodically saved when the checkpoint is saved into the flash media.
